(19) United States
(12) Patent Application Publication
(10) Pub. No.: US 2008/0202590 A1
(43) Pub. Date: Aug. 28, 2008

(54) High Efficiency Valve Geometry For Pressure Regulator

(75) Inventors: Timothy J. Farrow, Fort Collins, CO (US); Kyle R. Hickey, Fort Collins, CO (US); David G. Holloway, Fort Collins, CO (US)

Correspondence Address: REINHART BOERNER VAN DEUREN P.C., 2215 PERRYGREEN WAY, ROCKFORD, IL, 61107, US

(73) Assignee: WOODWARD GOVERNOR COMPANY, Fort Collins, CO (US)

(21) Appl. No.: 11/678,579

(22) Filed: Feb. 24, 2007

(51) Int. Cl. F16K 31/12

(52) U.S. Cl. 137/8; 137/505

(57) ABSTRACT

A pressure regulator that has a geometry that reduces regulator droop is provided that reduces or eliminates the need for a larger package size for a given set of flow requirements. The regulator comprises a housing having a fuel inlet port and a fuel outlet port; at least one regulation stage having an input in fluidic communication with the fuel inlet port; a final regulation stage comprising an inlet in fluidic communication with an output of the at least one regulation stage, a mating valve seat in fluidic communication with the inlet, and a valve seat in movable contact with the mating valve seat, the valve seat having a bottom having an edge, the edge having means for reducing regulator droop; and means for moving the valve seat from a closed position to an open position in response to a pressure change. The means for reducing regulator droop comprises a reverse lip or an approximately square edge.

### BACKGROUND

This invention generally relates to fuel systems and, more particularly, to a pressure regulator for a propane fuel system.

Pressure regulators are used in a large variety of automotive and industrial applications. Within these applications, the pressure regulator delivers a controlled fuel pressure to a downstream metering device, regardless of the fuel tank pressure, fuel flow rate or fuel temperature. In some applications, the regulator is a gaseous media pressure regulator that receives a liquid fuel at the regulator inlet, and vaporizes the fuel prior to the regulator outlet. This function is in addition to the primary function of pressure regulation.

One industrial application is mobile industrial applications where a pressure regulator is used such as in lift truck applications, more commonly referred to as forklifts. The mobile industrial applications are especially challenging from a fuel system standpoint because they have to be very cost competitive, have to be very compact due to space limitations in the engine compartment, and have high performance expectations based on certified system emissions and drivability requirements.

Regulator droop is a key performance criterion for gaseous media pressure regulators. Specifically with engine fuel system applications, regulator droop can cause fueling problems at higher engine load and speed conditions due to decreased fuel pressure and/or density delivered to the fuel system mixing device.

Regulator droop is defined as regulator outlet pressure decreasing with increasing flow media flow rate through the regulator. Sensing area, flow area, spring rate and general flow losses within a regulator are some key parameters that typically affect regulator droop. Changes in these parameters relative to improved droop performance generally involve increasing the size of the features to which these parameters are attributed. Given the typical application requirements of low cost, reduced package size and increased performance, increasing the size of the features contradicts the requirements of low cost and reduced package size.

### BRIEF SUMMARY

The high efficiency valve geometry described herein reduces droop through the regulator valve geometry for a given valve opening. Thus, the last parameter mentioned above, flow losses, is improved without increasing cost or part size. Advantages of the geometry, as well as additional inventive features, will be apparent from the description provided herein.

In one aspect, a lip is added to the bottom of the regulator final regulation stage soft seat that significantly reduces the regulator droop. A gain may also be realized by a similar modification(s) in and around the mating geometry of the final regulator stage hard valve seat. As mentioned above, improved droop performance allows for a smaller package size for a given set of flow requirements. The smaller package size results in an improved regulator package and reduced cost. A sharp square outer edge on the soft seat bottom also gives good performance.

Other aspects and advantages will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic view of an exemplary operating environment in which the regulator may operate;

FIG. 2 is a partial sectional view of the regulator in a closed position;

FIG. 3 is a partial sectional view of the regulator in an open position;

FIG. 4a is a graph illustrating the flow performance of the soft seats shown in FIGS. 4b to 4e;

FIG. 4b is a cross-sectional view of a soft seat of a regulator stage having a reverse lip edge;

FIG. 4c is a cross-sectional view of a soft seat of a regulator stage having a sharp edge;

FIG. 4d is a cross-sectional view of a soft seat of a regulator stage having a radius edge; and

FIG. 4e is a cross-sectional view of a soft seat of a regulator stage having a chamfer edge.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

Described herein is a pressure regulator that has a valve geometry that reduces regulator droop and that reduces or eliminates the need for a larger package size for a given set of flow requirements. The valve geometry also generally results in lower cost and improved manufacturability.

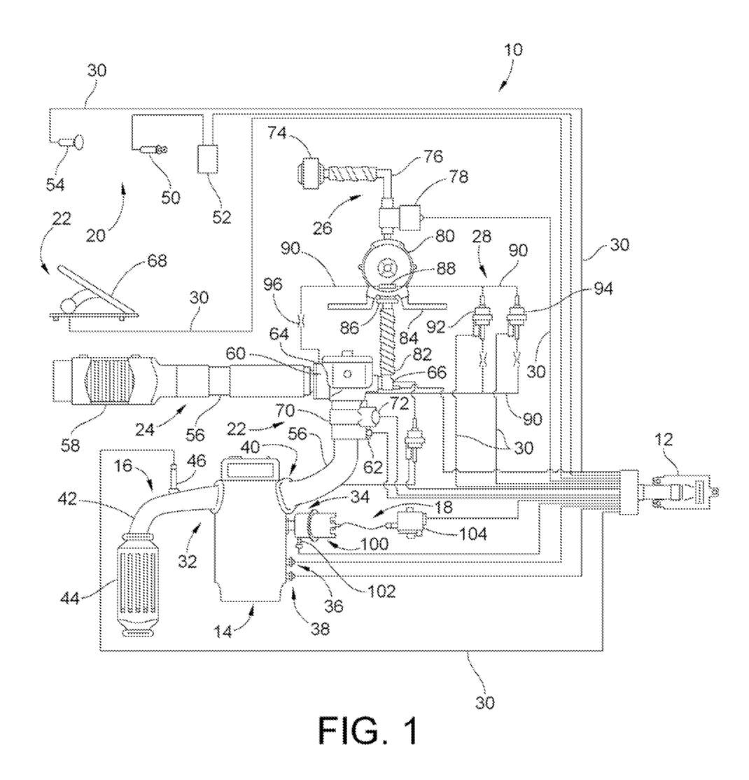

Prior to describing the regulator valve geometry, an overview of an exemplary environment in which the regulator can operate shall be described. Referring to FIG. 1, an engine system 10 is shown. The engine system 10 comprises an electronic control module (ECM) 12, a spark-ignited internal-combustion engine 14, an exhaust system 16, a spark-producing system 18, an ignition system 20, a throttle system 22, an air intake system 24, a fuel system 26, and a trim system 28.

The ECM 12 generally monitors, controls, and otherwise manages the operation of the engine system 10 and is operably coupled, via wiring 30 or otherwise, to the above-noted systems 16-28. The ECM 12 typically has full authority over spark, fuel, and air in the engine system 10. In one embodiment, the ECM 12 is one of the electronic control modules commercially available from Woodward Governor Company of Fort Collins, Colo. If desired, more than one ECM 12 can be utilized by the engine system 10.

The engine 10 operates using a vaporized liquid propane gas (LPG), natural gas, or other fuel. The engine 10 is particularly suited for an alternative-fueled off-highway vehicle. The engine 10 includes, among other things, an exhaust port 32, a spark coupling 34, an oil pressure switch 36, a coolant temperature sensor 38, and an air intake port 40.

The exhaust port 32 is generally coupled to the exhaust system 16. The exhaust system 16 comprises an exhaust pipe 42, a muffler 44 (including a catalyst), and an oxygen sensor 46. Note that the catalyst may be a separate component. The exhaust pipe 42 generally extends between the exhaust port 32 and the muffler 44 such that emissions and the by-products of combustion are routed away from the engine 14. The oxygen sensor 46 is disposed within the exhaust pipe 42 to sense a level of oxygen in the exhaust gases passing through the exhaust pipe, and thus can measure the equivalence ratio. The oxygen sensor 46 is operably coupled to and monitored by the ECM 12. The muffler 44 is employed to muffle the sound leaving the engine 14 and/or to reduce the level of contaminants in the emissions leaving the engine (i.e., a catalyst function). The muffler 44 is preferably one of a catalytic muffler, a three-way catalyst muffler, and the like.

The spark coupling 34 is generally coupled to the spark-producing system 18. In one embodiment, the engine system 10 employs a spark producing system 18 that comprises a distributor 100, a variable reluctance sensor 102, and a smart coil 104. The distributor 100, variable reluctance sensor 102, and smart coil 104 operate in conjunction with each other to provide a spark within the engine 14 to combust the fuel found therein. The smart coil 104 is configured to generate a spark. The smart coil 104 has built-in driver circuitry to eliminate the need for a driver circuit inside the ECM 12 or otherwise outside of the smart coil. The smart coil 104 is operably coupled to and monitored by the ECM 12. Although a smart coil 104 is illustrated in FIG. 1, other coil systems can be employed. In some systems, the distributor 100 is eliminated and a plurality of smart coils is used. Either type of spark-producing system 18 may be used with the invention.

The oil pressure switch 36 monitors the oil pressure within the engine 14. The coolant temperature sensor 38 monitors the temperature of the coolant flowing in and/or around the engine. Both the oil pressure switch 36 and the coolant temperature sensor 38 are operably coupled to and monitored by the ECM 12.

The ignition system 20 comprises a key switch 50, a power relay 52, and a fault light 54. The key switch 50 controls the activation and deactivation of the engine system 10. Using a key that has been correctly keyed and placed within the key switch 50, the key switch is moveable to a variety of positions pertaining to the operation of the engine system 10 and engine 14. For example, the key switch 50 can be switch into an “on” or “run” position, an “accessory” position, and an “off” or “lock” position.

The power relay 52 is used, for example, to provide power to the ECM when the key switch 50 has been placed in the “on” position. The fault light 54 is an indicator used to warn or alert an operator about conditions related to the engine system 10 such as, for example, that the engine 14 is running or stopped, that the equivalence ratio is undesirable, that one or more components of the engine system 10 are not operating properly or have failed, and the like. Each of the key switch 50, power relay 52, and fault light 54 are operably coupled to and monitored by the ECM 12.

The air intake port 40 (or plurality of ports) is operably coupled to the air intake system 24. The air intake system 24 includes an air duct 56, an air cleaner 58, a mixer 60, and a temperature/manifold absolute pressure (TMAP) sensor 62. The air duct 56, or air intake manifold, generally extends between the air intake port 40 and the air cleaner 58 such that a source of air is provided to the engine 14. The air duct 56 is able to carry air from the air cleaner 58, through the mixer 60, and to the air intake port 40 of the engine 14. Various other components (e.g., adapters, etc.) can be included and operably couple together the specifically referenced components. For example, there can be an adapter that plumbs the mixer to the throttle and another adapter the plumbs the throttle to the intake manifold. Other arrangements and mountings of the components are possible without detracting from the spirit of the invention.

The air cleaner 58 (i.e., air filter) removes contaminants and particles such as, for example, dust, debris, and the like, from the air. The air cleaner 58 is formed from paper, cotton, foam, synthetic materials, and the like.

The mixer 60 is disposed and/or incorporated into the air duct 56. The mixer 60 mixes, blends, and/or combines the air and the fuel. In one embodiment, the mixer 60 can be a venturi mixer, a variable venturi mixer, an air-valve mixer, and the like. The mixer 60 includes a reference pressure port 64 and an air valve vacuum port 66 that each pass into the air duct 56 and are exposed to the air therein. The reference pressure port 64 and the air valve vacuum port 66 may be integrally formed with the mixer 60 or mounted separately within the air duct 56 proximate the mixer. In the illustrated embodiment of FIG. 1, the reference pressure port 64 is disposed upstream of the mixer 60 (e.g., upstream of an air valve in the mixer) while the air valve vacuum port 66 is disposed downstream of the mixer (e.g., downstream of the air valve in the mixer). As such, the reference pressure port 64 and the air valve vacuum port 66 experience different pressures.

The TMAP sensor 62 is a sensing device that fits directly into the air duct 56 or is otherwise incorporated into the engine system such as in an intake manifold. As shown in FIG. 1, the TMAP sensor 62 is disposed downstream of the mixer 60 and the throttle 70. The TMAP sensor 62 includes a temperature sensor and a pressure transducer. As such, the TMAP sensor 62 is able to accurately measure temperatures and pressures. In one embodiment, the TMAP sensor 62 senses one or more of the vacuum draw from the engine 14, a vacuum in the air duct 56, and/or a barometric pressure depending on whether the key switch 50 is in the “on” position and whether the engine 14 is running or not. For example, the TMAP sensor 62 measures the pressure and temperature of the media proximate the air intake port. If the engine 14 is running and the application is normally aspirated, the pressure the TMAP sensor measures will be below atmospheric pressure. If, on the other hand, the application is turbocharged, the pressure the TMAP sensor 62 measures could be above or below atmospheric pressure depending on the boost level, throttle position, engine speed, and the like. If the engine is not running, the TMAP sensor 62 measures atmospheric pressure. The TMAP sensor 62 is operably coupled to and monitored by the ECM 12.

The throttle system 22 includes a foot pedal 68, a throttle 70, and a throttle position sensor (TPS) 72. The foot pedal 68 permits a user of a vehicle to control the position of the throttle 70. The throttle 70 is disposed within the air duct 56 downstream of the mixer 60 and is, in general, a type of valve used to control the flow of an air/fuel mixture into the engine 14. In one embodiment, the throttle 70 is a drive-by-wire throttle. Using the foot pedal 68 to control the throttle 70, the amount of the air/fuel mixture being delivered to the engine 14 is regulated to match the throttle position. As a result, the speed of the vehicle or the work output of the engine can be increased, decreased, or maintained.

The TPS 72 senses the position of the throttle 70. In one embodiment, the TPS 72 includes a linear variable resistor that produces a particular linear voltage relative to the position of the throttle 70. For example, when the engine 14 is at idle, the TPS 72 generates about 0.5 volts and when the throttle 70 is fully open and the engine is running at its maximum the TPS produces about four and a half (4.5)volts. Each of the foot pedal 68, the throttle 70, and the TPS 72 are operably coupled to and monitored by the ECM 12.

The fuel system 26 is operably coupled to a fuel source (e.g., a fuel tank) and includes a fuel filter 74, a fuel line 76, a fuel lock 78, a regulator 80, a fuel delivery line 82, and a coolant line 84. The fuel filter 74 is a device used to remove contaminants, debris, and/or particles from the fuel supplied by the fuel source. The fuel filter 74 is coupled to the fuel lock 78 by the fuel line 76. Because the fuel lock 78 is a normally-closed device, when unpowered the fuel lock 78 restricts or prevents the further delivery of fuel and is often vacuum or solenoid actuated. When powered, the fuel lock 78 is a passive device and permits the free flow of fuel. The fuel lock 78 is configured to terminate the supply of fuel to the engine system 10 when an emergency situation arises, when the engine fails, when the key switch 50 is in the “off” position, and the like, and is considered to be a safety device. The fuel lock 78 is operably coupled to and monitored by the ECM 12. The fuel lock 78 is also operably coupled to the regulator inlet.

The regulator 80, which can be a combination of a pressure regulator and vaporizer/heat exchanger, converts a liquid fuel such as, for example, liquid propane to either a gaseous fuel or a mixture of liquid and gaseous fuel and then regulates the pressure of the fuel. In other words, the regulator 80 vaporizes the liquid fuel and regulates the pressure of the fuel. The regulator 80 includes an outlet port 86 and a bias port 88. The outlet port 86 is operably coupled by the fuel delivery line 82 to the mixer 60. As such, the vaporized fuel is able to flow from the regulator 80 into the mixer 60.

The regulator 80 typically uses the heat generated from the engine 14 to assist in the process of vaporizing the fuel. As shown in FIG. 1, the coolant line 84 carries a coolant that has absorbed some of the heat generated by the engine 14. The heated coolant is flowed inside or proximate the regulator 80 and the heat from the coolant aids in the vaporization of the fuel. It should be noted that the coolant line 84 is not shown connected to anything other than the regulator 80. It is illustrated this way for clarity and need not be shown in further detail as those skilled in the art will recognize how the coolant line 84 is routed.

Liquid fuel such as propane enters the regulator 80 and then is vaporized by heat from the engine coolant via coolant line 84 and a pressure drop across a primary pressure regulation stage within the regulator 80. Heat is transferred to the fuel by the coolant heated passages (heat exchanger) within the regulator 80. The regulator controls the fuel pressure by metering the fuel flow. The pressure at the bias port 88 alters the pressure of, and therefore the amount of, fuel that flows into the mixer 60. When engine demand draws fuel from the low-pressure side of the regulator 80, the regulator opens, letting liquid fuel expand across the primary pressure regulation stage and then flow into the coolant heated chamber, continuing the vaporization process.

Still referring to FIG. 1, the trim system 28 comprises a balance line 90, a first trim valve 92, and a second trim valve 94 operably coupled to and operating in conjunction with the mixer 60 and the converter 80. The balance line 90 is configured to permit the flow of air therethrough and to carry air to and from the air duct 56. In particular, the balance line 90 permits air to flow from the upstream side of the mixer 60 (e.g., upstream of the air valve in the mixer), through the trim system 28, then to the downstream side of the mixer (e.g., downstream of the air valve in the mixer). The reference pressure port 64, the bias port 88, and the air valve vacuum port 66 are each operably coupled to the balance line 90. The balance line 90 provides fluid (e.g., air) communication between the reference pressure port 64, the bias port 88, and the air vacuum valve port 66. In one embodiment, the balance line 90 includes an orifice 96 to partially restrict the flow of air. The trim valves 92, 94 can also be resized by installing additional orifices (e.g., 96) upstream or downstream of each trim valve.

The first and second trim valves 92, 94 are disposed in the balance line 90 and in fluid communication with the reference pressure port 64, the bias port 88, and the air vacuum valve port 66. The first and second trim valves 92, 94, in conjunction with the orifice 96, are operable to adjust the pressure at the bias port 88 and thereby control a flow, mass, and/or volume of fuel flowing through the fuel delivery line 82. As such, the first and second trim valves 92, 94 are able to control and/or manage the equivalence ratio (i.e., either phi (φ) or lambda (λ)) of the engine system 10 relative to a control signal from the ECM 12.

For example, if the trim valves 92, 94 permit too much fuel to flow through the fuel delivery line 82, the air/fuel ratio becomes too rich. On the other hand, if the trim valves 92, 94 permit too little fuel to pass, the air/fuel ratio becomes too be lean. Either of these circumstances results in the engine 14 operating poorly and/or inefficiently. However, if the trim valves 92, 94 allow the proper amount of fuel to pass, stoichiometry is achieved (i.e., lambda approaches one) and the engine 14 runs smoothly, efficiently, and with minimal post-catalyst emissions.

In operation, after the ignition system 20 is used to activate the engine system 10, air is drawn through the air cleaner 58 and flows through the air duct 56 to the mixer 60. Simultaneously, fuel (e.g., liquid propane) is introduced into the regulator 80, vaporized, pressure-regulated and then routed into the mixer 60 via the fuel delivery line 82.

Now that the system has been described, the geometry of the regulator shall be described. It should be noted that the regulator may be used in other environments, including those described in U.S. patent application Ser. No. 11/379,458, hereby referenced in its entirety. The description shall be based on a “negative pressure” propane regulator. Regulator “set” pressure is the pressure the regulator attempts to maintain when flowing. The “set” pressure for a “negative pressure” regulator will be below atmospheric pressure. Therefore, the system and/or components connected to the regulator outlet 86 must pull the regulator pressure down to the “set” pressure before the regulator will begin to flow. The function of other regulator types may differ slightly, but the basic principles are the same.

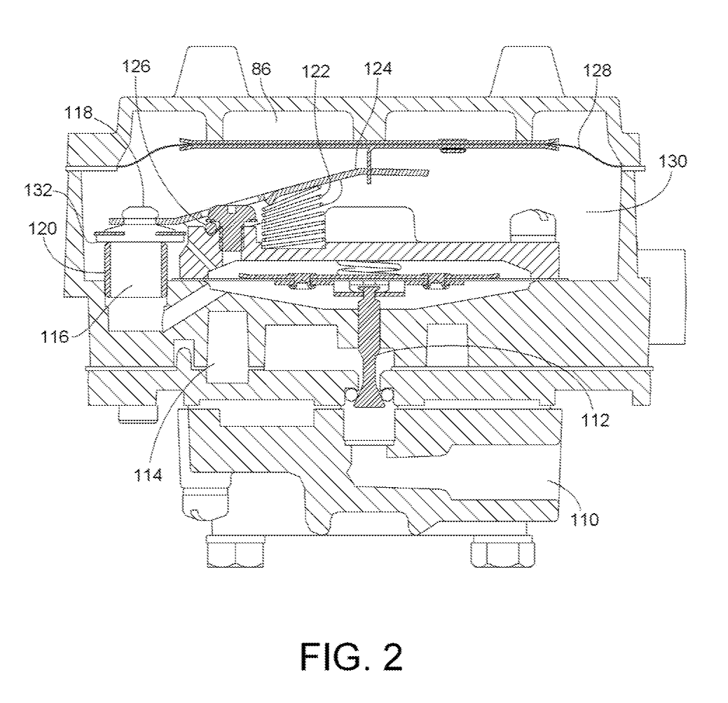

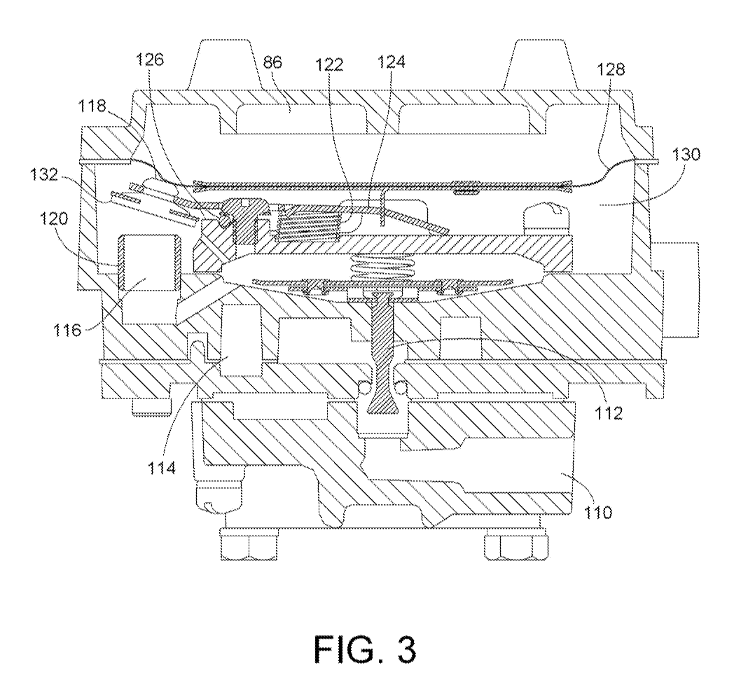

The pressure regulator 80 functions as follows. Referring additionally to FIG. 2 and FIG. 3, flow media enters the regulator through an inlet port 110. The flow media may travel through one or more regulation stages 112 prior to the final regulation stage depending on the overall pressure drop across the device and the performance requirements. The regulator may also include a heat exchanger 114, as is common for propane regulators. A propane regulator receives liquid propane at the regulator inlet 110. The propane then flashes to vapor due to the pressure drop through the upstream pressure regulation stage(s) 112 and heat provided by the heat exchanger 114. Next, the flow media enters the inlet 116 of the final regulation stage.

A given regulation stage can be normally-closed or normally-open, defined by its valve state when it is not pressurized. The final regulation stage of a negative-pressure propane regulator is normally-closed, and thus a soft valve seat 118 is in contact with the mating hard valve seat 120. This closed state is achieved by a force from the spring 122 pushing up on the lever 124. The lever 124 pivots around the pivot pin 126 and transfers the spring force to the seat 118. The mixer 60 or other component immediately downstream of the regulator 80 instigates a vacuum on the outlet of the regulator 80 during the beginning of system operation. This reduction in pressure creates a pressure force on the diaphragm 128 that in turn pushes down on the lever 124. Once the pressure reaches the “regulation pressure” value, the diaphragm pressure force overcomes the spring force and the valve begins to open. As the valve opens, it allows flow media to flow into the outlet chamber 130. The regulator 80 will attempt to maintain the regulator “set” pressure, i.e. opening further for higher system flow rates and opening less for lower system flow rates. However, the actual regulated pressure varies due to regulator droop, friction and other factors.

Regulator droop is defined as regulator outlet pressure decreasing with increasing flow media flow rate through the regulator 80. Droop is explained as follows. As flow rate through the regulator increases, the regulator valve(s) must open further in an attempt to maintain a constant pressure in the regulator outlet chamber 130. The force, F, from a spring is a function of its compression, x, and spring rate, k, and is defined in equation form as F=k*x. As the regulation valve opens further due to an increased flow rate, the spring 122 is also compressed further. Given the equation above, and a constant spring rate, the spring force must also increase as the spring deflection increases. This increase in spring force must be countered by an increase of the pressure delta across the diaphragm 128, and therefore a further reduction in the outlet chamber pressure, i.e. droop, occurs. Flow losses due to increases in flow rate can also contribute significantly to droop.

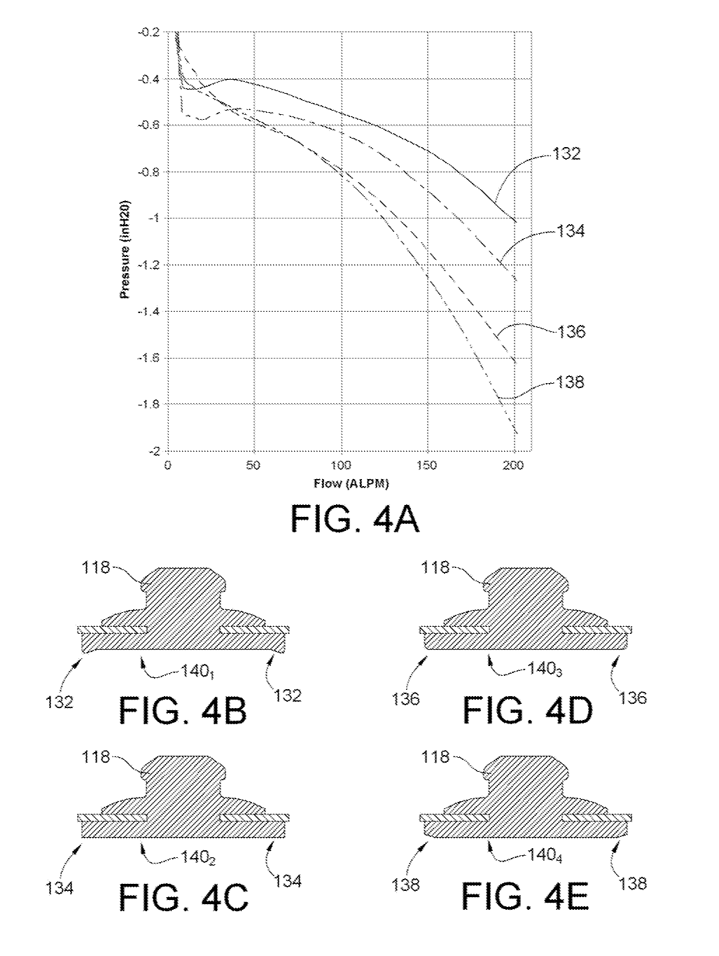

Turning now to FIGS. 4A through 4E, the regulator droop is reduced by changing the features of the edge of the bottom of the soft seat 118. In one embodiment, a reverse lip 132 is added to the edge of the bottom 140₁, of the regulator final regulation stage soft seat 118. The reverse lip 132 significantly reduces the regulator droop, as can be seen in FIG. 4a. A gain may also be realized by a similar modification(s) in and around the mating geometry of the hard valve seat 120. As mentioned above, improved droop performance allows for a smaller package size for a given set of flow requirements. The smaller package size results in an improved regulator package and reduced cost.

Flow testing results of multiple regulators with “lipped” seats has shown a reduction in part-to-part variation in relation to the regulator pressure vs. flow curves. This is due to the sensitivity of the regulator flow performance to the condition of the bottom outer edge of the soft seat 118.

As can be seen in FIG. 4a, a sharp square outer edge 134 (see FIG. 4c) on the soft seat bottom 140₂ also gives good performance (although not as good as the “lipped” version). However, the sharp square bottom edge can be difficult to manufacture consistently due to damage that can occur as the part is ejected from the mold. Since the bottom outer edge of the “lipped” version of the seat contains a generous radius, manufacturability is good. A radius 136 on the soft seat bottom 140₃ or a chamfer 138 on the soft seat bottom 140₄ does not provide as good performance as the lip 132 or sharp edge 134.

From the foregoing, it can be seen that a regulator having a geometry that reduces regulator droop has been provided. Without the use of the regulator geometry, a larger package size is needed for a given set of flow requirements.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments are described herein, including the best mode known to the inventors. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A pressure regulator for use in a fuel system, the pressure regulator having a housing having a fuel inlet port and a fuel outlet port, the outlet port operably coupled to deliver vaporized fuel to a component, the pressure regulator comprising:
at least one regulation stage having an input in fluidic communication with the fuel inlet port;
a final regulation stage comprising:
an inlet in fluidic communication with an output of the at least one regulation stage;
a mating valve seat in fluidic communication with the inlet;
a valve seat in movable contact with the mating valve seat, the valve seat having a bottom having an edge, the edge having means for reducing regulator droop; and
means for moving the valve seat from a closed position to an open position in response to a pressure change.

2. The pressure regulator of claim 1 wherein the means for reducing regulator droop comprises a reverse lip,

3. The pressure regulator of claim 1 wherein the means for reducing regulator droop comprises an approximately square edge.

4. The pressure regulator of claim 1 wherein the means for moving the valve seat comprises:
a lever connected to the valve seat and pivoting around a pivot pin during operation;
a spring connected to the lever and having a spring force pushing up on the lever, the lever transferring the spring force to the valve seat to provide a closing force on the valve seat; and
a diaphragm connected to the lever responsive to a change in pressure on the fuel outlet port such that a diaphragm pressure force overcomes the spring force to open the valve once the pressure on the fuel outlet port reaches a regulation pressure.

5. The pressure regulator of claim 1 further comprising a heat exchanger in the housing.

6. The pressure regulator of claim 1 further comprising a flow path to connect the inlet to the output of the at least one regulation stage.

7. A method to reduce regulator droop in a pressure regulator having a valve and valve seat in a final regulation stage comprising the step of providing a structural feature to the valve seat.

8. The method of claim 7 wherein the structural feature is at least one reverse lip on a bottom of the valve seat.

9. The method of claim 8 wherein the structural feature is a reverse lip on an edge of the bottom of the valve seat.

10. The method of claim 7 wherein the structural feature is at least one approximately square edge on a bottom of the valve seat.
